(19) United States
(12) Patent Application Publication
(10) Pub. No.: US 2004/0120333 A1
(43) Pub. Date: Jun. 24, 2004

(54) Method and apparatus for controlling information flow through a protocol bridge

(76) Inventors: David Geddes, Fremont, CA (US); Michael Moretti, Saratoga, CA (US); Salil Suri, Fremont, CA (US); Scott Furey, Cupertino, CA (US); Thomas Wu, Pleasanton, CA (US)

Correspondence Address: IRELL & MANELLA LLP, 840 NEWPORT CENTER DRIVE, SUITE 400, NEWPORT BEACH, CA, 92660, US

(21) Appl. No.: 10/434,872

(22) Filed: May 8, 2003

Related U.S. Application Data
(60) Provisional application No. 60/436,222, filed on Dec. 24, 2002.
(60) Provisional application No. 60/436,215, filed on Dec. 24, 2002.

(51) Int. Cl. H04L 12/56

(52) U.S. Cl. 370/411; 370/465; 370/400

(57) ABSTRACT

A method and apparatus for controlling information flow through a protocol bridge is disclosed. In one embodiment, circular queues in dual port memory are used for passing frame header information and control information between the hardware and a processor. In one embodiment, a ‘control bit’ in each element in the dual port memory serves as a signaling mechanism for passing control of the circular queue elements between the hardware and the software. In another embodiment, a ‘skip bit’ is used to simplify error handling by enabling the circular queue elements to be processed in a particular order even under error conditions.

### CROSS REFERENCE TO RELATED APPLICATIONS

This application is related to and claims priority from provisional application serial No. 60/436,222, entitled “Method and Apparatus for Controlling Information Flow Through a Protocol Bridge,” and provisional application serial No. 60/436,215, entitled “Method and Apparatus for Generation of Headers in a Protocol Bridge,” both of which were filed on Dec. 24, 2002.

### BACKGROUND OF THE INVENTION

1. Field of the Invention

The present invention relates in general to data networks and more particularly, to a method and apparatus for controlling information flow through a protocol bridge.

2. Background of the Invention

Fibre Channel is a computer communications protocol designed to provide for higher performance information transfers. Fibre Channel allows various existing networking protocols to run over the same physical interface and media. In general, Fibre Channel attempts to combine the benefits of both channel and network technologies.

A channel is a closed, direct, structured, and predictable mechanism for transmitting data between relatively few entities. Channels are commonly used to connect peripheral devices such as a disk drive, printer, tape drive, etc. to a workstation. Common channel protocols are Small Computer System Interface (SCSI) and High Performance Parallel Interface (HIPPI).

Networks, however, are unstructured and unpredictable. Networks are able to automatically adjust to changing environments and can support a larger number of connected nodes. These factors require that much more decision making take place in order to successfully route data from one point to another. Much of this decision making is done in software, making networks inherently slower than channels.

Fibre Channel has made a dramatic impact in the storage arena by using SCSI as an upper layer protocol. Compared with traditional SCSI, the benefits of mapping the SCSI command set onto Fibre Channel include faster speed, connection of more devices together and larger distance allowed between devices. In addition to using SCSI, several companies are selling Fibre Channel devices that run Internet Protocol (IP).

With increasing use of Fibre Channel technology, the need for transferring data between Fibre Channel devices and non-Fibre Channel devices has also increased. This data transfer requires that the originating protocol be translated to the protocol of the destination network/channel. Traditional protocol bridges process data frames in an inefficient manner. As such, there is a need for an improved system for controlling information flow through a protocol bridge.

### BRIEF SUMMARY OF THE INVENTION

Methods and apparatus for bridging network protocols are disclosed. The method comprises receiving a data frame having a source protocol using a first interface, storing a header of the data frame in a first entry of a plurality of memory queues in response to an output from a circuit, and notifying, by the circuit, a processor of the data frame upon storing a programmable number of bytes of the data frame. The method further comprises assuming control, by the processor, of the first entry after said notifying, and generating an outgoing header using the processor based on information in the header, the outgoing header to have a destination protocol.

Other embodiments are disclosed and claimed herein.

### BRIEF DESCRIPTION OF THE DRAWINGS

FIGS. 1A-1B illustrate a block diagram of one embodiment of an ASIC capable of carrying out one or more aspects of the present invention.

FIGS. 2A-2B is a flow diagram of one embodiment of how egress frames may be processed by the ASIC of FIGS. 1A-1B.

FIGS. 3A-3B is a flow diagram of one embodiment of how ingress frames may be processed by the ASIC of FIGS. 1A-1B.

FIG. 4 contains a tabulated embodiment of the control fields that may be used in the generation of header frames consistent with the principles of the invention.

### DETAILED DESCRIPTION OF EXAMPLARY EMBODIMENTS

One aspect of the invention relates to the use of circular queues in dual port memory for passing packet/frame header information and control information between the hardware and the microprocessor. In one embodiment, a ‘control bit’ in each element in the dual port memory serves as a signaling mechanism for passing control of the circular queue elements between the hardware and the software. In another embodiment, a ‘skip bit’ may also be used to simplify error handling by enabling the circular queue elements to be processed in a particular order even under error conditions.

Another aspect of the invention is to use extra space in circular queue elements for small payloads generated by the internal microprocessor. The use of extra space in the circular queue elements may also be used for optional header generation by the microprocessor, according to one embodiment. In yet another embodiment, a Special Payload Buffer may be used for larger payloads generated by the microprocessor.

A further aspect of the invention is to automatically segment Packet-Over-SONET (POS) frames into smaller Fibre Channel frames. In one embodiment, POS frames are automatically segmented when a received POS frame's payload is larger than the buffer location (e.g., a segment) in which it is to be stored.

Yet another aspect of the invention is to provide a hybrid hardware/software mechanism for generating frames in a protocol bridge. In one embodiment, the selection and operation of the source for header information is controlled on a frame-by-frame basis by fields in the control section of a header queue entry associated with each frame.

I. Hardware Design

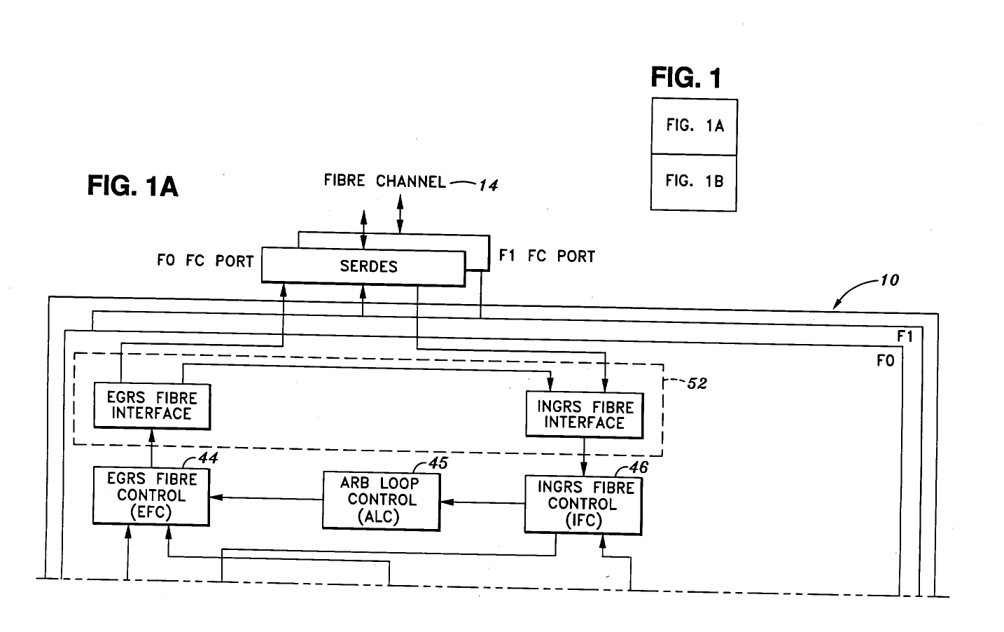

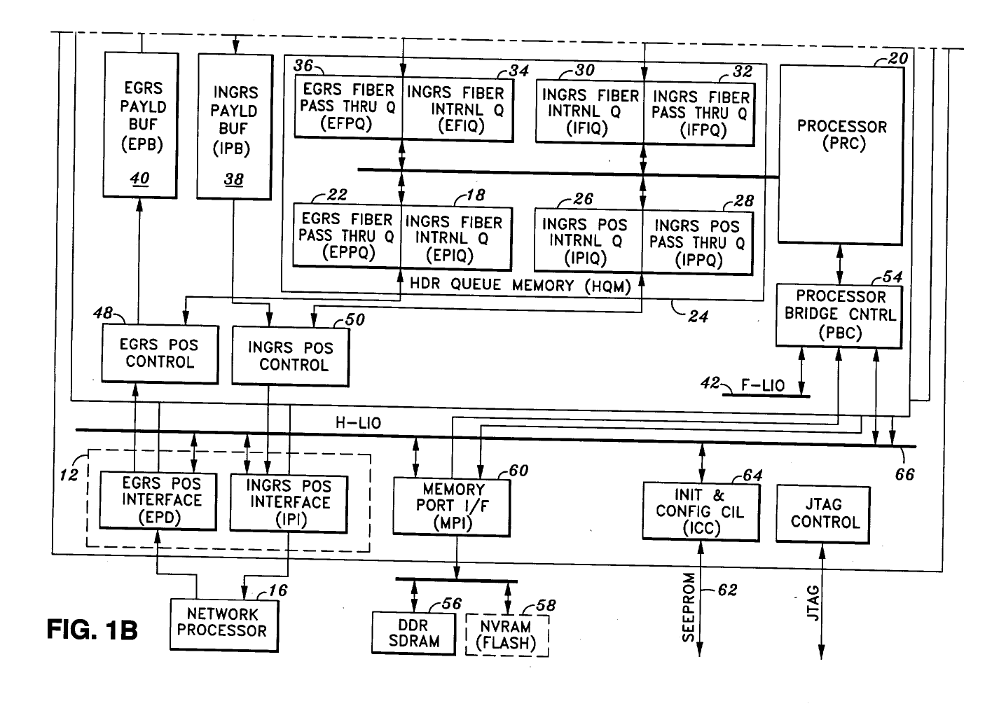

Referring now to FIGS. 1A-1B, in which a block diagram of one embodiment of an ASIC 10 capable of carrying out one or more aspects of the present invention is illustrated. In the embodiment of FIGS. 1A-1B, the ASIC 10 includes two Fibre Channel (FC) ports, F0 Port and F1 Port, with hardware associated with the F0 Port residing on the F0 function level and hardware associated with the F1 Port residing on the F1 function level. It should be appreciated, however, that there may be more or fewer FC ports and one or more of the hardware components for different FC functions may be integrated onto the same function level.

Ingress (Ingrs) and egress (Egrs) references in FIGS. 1A-1B describe the data path direction between the Packet-over-SONET Physical Layer (POS/PHY—abbreviated as POS hereafter) interface 12 and the Fibre Channel 14. The following discussion refers to those frames received from the POS interface 12 and routed to one of the two Fibre Channel ports (F0 or F1) as ‘egress frames,’ while frames that are received from the Fibre Channel 14 and routed to the POS intergave 12 will be referred to generally as ‘ingress frames.’ However, while FIGS. 1A-1B and the following description are directed to sending and receiving data between a Fibre Channel interface and a POS interface, it should equally be appreciated that the principles of the invention may similarly be applied to other network protocols and other applications. For example, rather than having a POS interface 12 coupled to a POS network, the interface may be a System Parallel Interface (a/k/a System Packet Interface), Utopia or the interface marked by AMCC Inc. under the name FlexBUS™. Similarly, rather than having a Fibre Channel interface coupled to Fibre Channel 12, ASIC 10 may be interfaced to an IEEE-1394, Infiniband, and/or iSCSI network. However, for brevity the following discussion with refer to only POS networks and Fibre Channel.

The Network Processor 16 may be any processor to which the ASIC 10 interfaces through the POS interface. The Egress POS Internal Queue (EPIQ) 18 may contain headers of frames received from the POS interface 12. In one embodiment, POS frames that will be processed by the internal embedded processor (PRC) 20 are routed to the EPIQ 18. While in one embodiment PRC 20 is a RISC processor, it may also be a Programmable Sequencer or be comprised of one or more Hardware Finite State Machines (FSM). Similar processing engines may also be used. The Egress POS Pass Through Queue (EPPQ) 22 may contain headers of POS frames received from the POS interface, where the payloads for such POS frames are intended to pass through the ASIC 10 to Fibre Channel 14. In the embodiment of FIG. 1B, both EPIQ 18 and EPPQ 22 are circular queue elements residing in the Header Queue Memory (HQM) 24.

Continuing to refer to FIGS. 1A-1B, the Ingress POS Internal Queue (IPIQ) 26 may contain headers of POS frames that have been generated by PRC 20. In addition, the Ingress POS Pass Through Queue (IPPQ) 28 may contain headers for POS frames whose payloads were received from the Fibre Channel 14. Ingress Fibre Internal Queue (IFIQ) 30, as shown in FIG. 1B, may contain headers of frames received from the Fibre Channel 14. In one embodiment, FC frames whose payloads will be processed by the PRC 20 may be routed to the IFIQ 30. Moreover, Ingress Fibre Pass Through Queue (IFPQ) contains headers of frames received from the Fibre Channel 14, according to one embodiment. FC frames whose payloads will pass through the ASIC 10 to the POS interface 12 may be also be routed to the IFPQ 30.

In the embodiment of FIGS. 1A-1B, the Egress Fibre Internal Queue (EFIQ) 34 may contain headers of FC frames that have been generated by the PRC 20. In that case, the frames may be sent out on the Fibre Channel 14. Moreover, the Egress Fibre Pass Through Queue (EFPQ) 36 contains headers of FC frames whose payloads were received from the POS interface 12, according to another embodiment.

In one embodiment, the circular queue elements of HQM 24 (e.g., EFPQ 36, EFIQ 34, EPPQ 22, EPIQ 18, IFIQ 30, IFPQ 32, IPIQ 26, and IPPQ 28) are shared dual-port RAM queues that are accessible by the ASIC 10 hardware logic as well as by the PRC 20.

The Egress POS Control (EPC) 48 module may be used to provide read functionality to transfer data from the Network Processor 16 (or associated memory) to the Egress Payload Buffer (EPB) 40 module or to the Egress POS queue memory of HQM 24. Similarly, the Ingress POS Control (IPC) 50 module may be used to provide the DMA write function to transfer data to the Network Processor 14 (or associated memory) from the Ingress Payload Buffer (IPB) 38 module or the Ingress POS queue memory of HQM 24.

The IPB 38 of FIG. 1B may contain payloads for frames that will be sent to the POS Interface 12. It should be appreciated that the payloads may have come from the Fibre Channel 14 or may have been created internally by the PRC 20. Moreover, the EPB 40 may contain payloads for frames that will be sent out on the Fibre Channel 14, where the payloads may either have come from the POS interface 12, or may have been created by the PRC 20.

The Fibre Channel interface provides the interface and control between the Fibre Channel and the ASIC 10. In the embodiment of FIG. 1A, the Fibre Channel interface consists of 4 major modules—the Egress Fibre Channel Control (EFC) 44, Arbitrated Loop Control (ALC) 45, Ingress Fibre Channel Control (IFC) 46 and Fibre Channel Interface (FCI) 52 modules. In particular, the EFC module 44 may be used to provide the frame flow control mechanism of the FC transmitting port (i.e., F0 or F1), while other operations which may be performed by the EFC module 44 include frame assembly, CRC generation, and retransmission of certain data from the ALC module 45 (e.g., L_Port data). In one embodiment, the EFC module 44 assembles and transmits frames to the FCI module 52 based on the data from HQM 24, EPB 40, and the ALC module 45.

In the embodiment of FIG. 1, the ALC module 45 is located between the IFC module 46 and EFC module 44. In one embodiment, this module consists primarily of a Loop Port State Machine (LPSM) whose main function is to continuously monitor the data stream coming from the IFC module 46. The LPSM may further be used to monitor commands from the PRC 20 and the EFC module 44. In one embodiment, the EFC 44 may send a command to the LPSM which defines the function to be performed by the ALC module 45 such as loop arbitration, open loop, close loop, etc. In another embodiment, the LPSM may be controlled by the PRC 20.

In one embodiment, the ALC module 45 may be used to detect different primitive signals or sequences (e.g., LIP, LPE, LPB, MRK, NOS, OLS, LR and LRR) and respond accordingly. In the loop topology, data from the IFC module 52 may be either passed on to the EFC module 44, or substituted with a primitive sequence depending on the function to be performed. The substitution may be either by the state machine itself or signaled from the EFC module 44.

The IFC module 36 may receive a data stream from the FCI module 52 and provides functions that may include frame disassembling, frame header matching and routing, FC_FS primitive signal and sequence detection, CRC checking and link interface integrity measurement. In one embodiment, the data received from the FCI module 52 is passed on to the ALC module 45 for retransmission during a private/public loop (L_Port) monitoring state. When not in the monitoring state, each frame received may be examined and routed to the appropriate destination modules. If the frame has a payload, the payload may be written into the next available buffer segment in the IPB module 38, according to one embodiment.

The Processor Bridge Controller (PBC) module 54 provides the interfaces that connects the embedded processor (e.g., PRC 20) to the rest of the ASIC 10 hardware. In the embodiment of FIG. 1B, PRC 20 is coupled to the PBC module 54 via a PIF bus, which may be a general purpose I/O bus that supports burst reads and writes as well as pipelined single access reads and writes. In another embodiment, PRC 20 can also use the PBC module 54 to interface with external memory devices such as DDR SDRAM 56 and NVRAM 58 attached to the ASIC 10 through the Memory Port I/F (MPI) module 60, or SEEPROM 62 through the Initialization and Configuration Control (ICC) module 64. In yet another embodiment, the PBC module 54 may also provide bidirectional bridging between the F_LIO bus 42 and Host Local I/O (H_LIO) bus 66. In one embodiment, F_LIO bus 42 may be used to provide access to registers in other hardware blocks through arbitration.

As previously mentioned, the MPI module 60 may be used to provide arbitrated accesses to external memory (e.g., DDR SDRAM 56 and/or NVRAM 58) devices by the PRC 20, as well as to every bus master on the internal H_LIO bus 66.

In one embodiment, the ICC module 64 includes a Serial Memory Control (SMC) module, which can be used to initialize internal registers and provide read/write access to SEEPROM 62. The ICC 48 may also include a trace control module (not shown) to provide external visibility of the internal signals.

II. Frame Egress

A. Egress Frame Processing

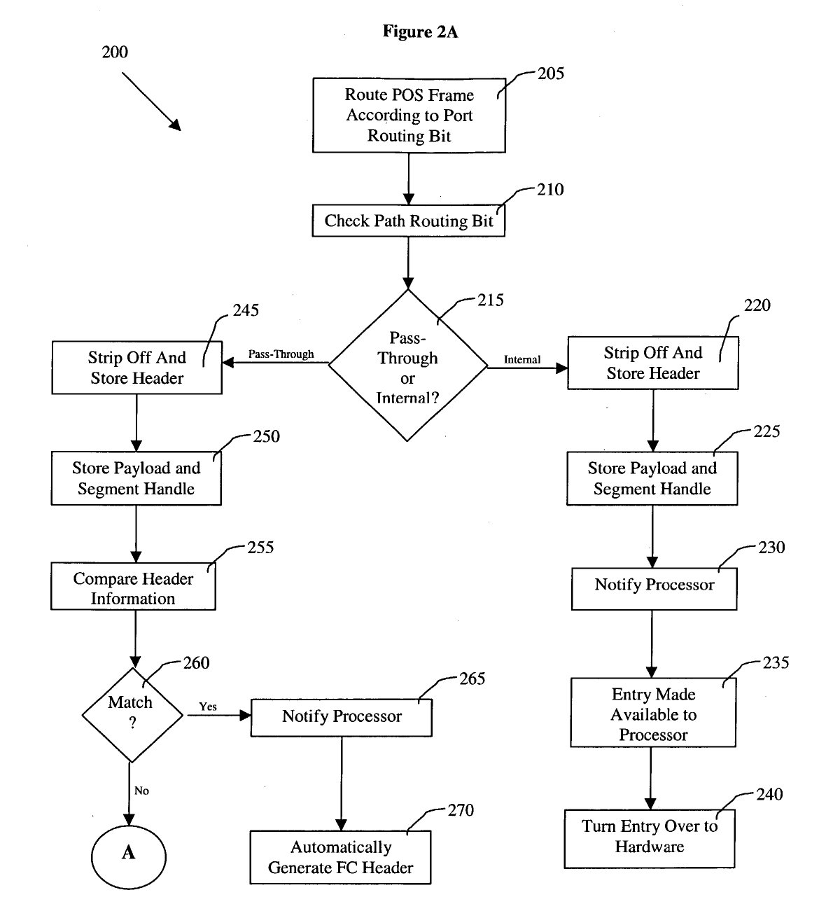

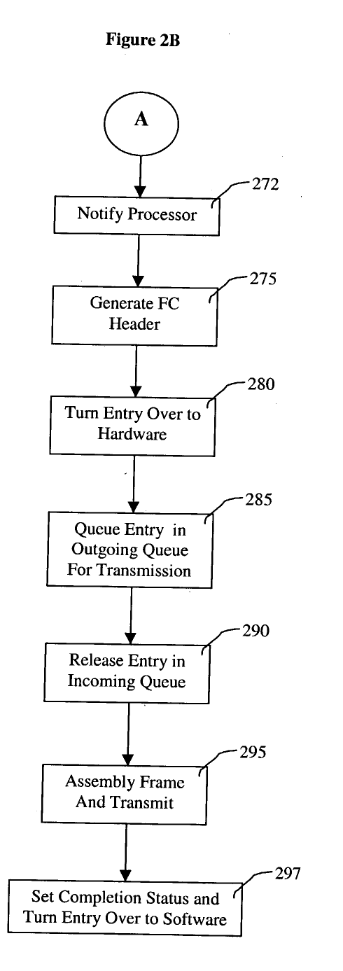

Referring now to FIG. 2, which is a simplified flow diagram of one embodiment (process 200) of how an egress frame may be processed by the ASIC 10. Once an egress frame is received on the POS interface 12, a port routing byte may be used to route the given frame to one of the FC function levels (e.g., F0 or F1)(block 205). In one embodiment, the port routing byte is located in the third byte of the frame header, although it may equally be located elsewhere in the frame. As mentioned previously, there may be more or fewer than two FC function levels, in which case the frames received from the POS interface 12 would be routed to whatever number of available FC function levels there may be.

After the frame arrives at the selected function (e.g., F0 or F1 in this embodiment), a second routing decision may then be made based on a path routing bit (block 210). In one embodiment, the path routing bit is located in the POS frame header, and may be located in one of the first four bytes of the POS frame header. The path routing bit may be used to determine whether the frame will be routed to the “Pass-Through Path” or to the “Internal Path,” where the Pass-Through Path is for frames containing payloads that are going to be sent out on the Fibre Channel 14, and the Internal Path is for frames whose payloads contain configuration or control information that will be used by the PRC 20 and not sent out on Fibre.

In one embodiment, where a determination has been made at decision block 215 that the frame is to be routed through the Internal Path, process 200 continues to block 220 where the received frame header is stripped from the payload and stored in an entry in an Egress POS Queue (such as EPIQ 18), which in one embodiment is dedicated to the selected function/path. A programmable number of bytes from the payload may also be stored along with the frame header in the HQM 24, according to another embodiment.

Thereafter, at block 225, the payload may then separated from the frame and stored in the next available segment of the EPB 40 for the given FC function (F0 or F1). A handle indicating which payload segment was used may also be stored by the hardware in the HQM 24 queue which received the POS frame header. At this point, the PRC 20 may be notified that a frame has been received, while in another embodiment the PRC 20 is notified before the entire payload has been received (block 230).

Once the PRC 20 is aware of the Internal Path frame, a programmable number of payload bytes may be made available to the PRC 20 in the entry in the EPIQ 18 (block 235). In one embodiment, the EPIQ 18 may be made available to the PRC 20 in zero-wait-state memory. Moreover, additional payload bytes may be made available to the processor via the F_LIO bus 42 (e.g., F0_LIO and F1_LIO).

After the PRC 20 has finished processing the information from the frame, it may release the entry in the EPIQ 18 to the hardware (block 240). In one embodiment, this is done by resetting a bit in the control word of the entry. In another embodiment, the PRC 20 also returns the payload buffer segment to the free pool by writing a segment handle to the payload segment release register.

If, on the other hand, a determination was made at block 215 that the frame is to be routed to the Pass-Through Path, process, 200 would continue to block 245 where the received frame header is stripped from the payload and stored in an entry in an Egress POS Queue (such as EPPQ 22) which may be dedicated to the selected function/path. A programmable number of bytes from the payload may also be stored along with the frame header in the HQM 24, according to another embodiment.

At block 250, the payload may then separated from the frame and stored in the next available segment of the EPB 40 for the given FC function (F0 or F1). A handle indicating which payload segment was used may also be stored by the hardware in the HQM 24 queue which received the POS frame header.

Thereafter, the frame header may be compared with the corresponding bytes from the previous frame's header (block 255). If the contents of the bytes are equal, a ‘header match’ bit in the HQM 24 entry (e.g., EPPQ 22) may be set indicating that the frames belong to the same context. It should be noted that the location of the bytes to be compared may be programmable via a bit mask.

A determination of whether the header match bit has been set may then be made at decision block 260. If so, the PRC 20 may be notified that a frame has been received and that the header match bit has been set (block 265). The PRC 20 may then be used to automatically generate portions of the FC header based on values from the header of the previous FC frame (block 270). This automatic header generation will be described in more detail below in Section IV.

If, on the other hand, the determination of decision block 260 indicates that the frame is from a different context than the previous frame (e.g., header match bit not set), the process 200 continues to block 272 of FIG. 2B where the PRC 20 is notified that a frame has been received and that the header match bit was not set. At this point, the PRC 20 may be used to write the information necessary to create a suitable FC frame header (block 275). In one embodiment, the FC frame header is created in the next available entry in the EFPQ 36, although it may also be stored elsewhere. In one embodiment, the PRC 20 may also copy the payload segment handle to this EFPQ 36 entry.

After the PRC 20 has finished setting up the outgoing frame header in the EFPQ 36, control of the HQM 24 entry may then be turned back over to the hardware by setting a bit in the entry's control word (block 280). However, it should be understood that other methods for releasing the entry may also be used. Once control of the HQM 24 entry has been turned over to the hardware, at block 285 the entry may then be queued up for transmission from one of the FC Ports. In one embodiment, frames that are released to the hardware are sent out on the FC Ports in the order in which they were released by the PRC 20. However, it should be appreciated that frames may be sent out in any number of other orders.

After the PRC 20 has set up an outgoing entry in the EFPQ 36, at block 290 the PRC 20 may also release the entry in the incoming EPPQ 22. In one embodiment, the entry is released by resetting a bit in the control word of the entry. Once released, the entry location may be reused for another egress POS frame header.

According to the embodiment of FIG. 2B, when the entry in the EFPQ 36 reaches the head of an HQM 24 queue, the hardware may automatically assemble an FC frame and send it out on the Fibre Channel 14 (block 295). When this has been completed, the hardware may put the completion status of the operation into the EFPQ 36 entry and turn the entry back over to the software (e.g., PRC 20) at block 297. The EPB 40 segment may also be returned to the free pool, or it may be returned by the PRC 20 after it checks the completion status in the HQM 24 entry.

It should further be appreciated that the PRC 20 may undertake a variety of additional operations at various points during process 200 depending upon several factors, including the path and contents of the frame, whether initialization has been completed, and in the case of an FCP frame, whether a command context already exists. For example, if the PRC 20 needs to generate an egress FC frame, in one embodiment it may do so using the EFIQ 34 and a Special Payload Buffer (not shown). In one embodiment, the Special Payload Buffer is a single segment buffer consisting of 512 bytes and resides in zero-wait-state processor memory. After the PRC 20 has put the required information into the HQM 24 entry (e.g., in the EFIQ 34 entry) and Special Payload Buffer, the frame may then be released to the hardware by setting a bit in the HQM 24 entry, causing the frame to be sent out when the entry reaches the head of the particular queue.

B. Optional Headers

When a POS frame is received, its payload may be placed into an entry in the EPB 40. For Pass-Through payloads, the PRC 20 may occasionally be required to insert an optional FC header between the FC header and the payload received from the POS interface 12. In order to accommodate this, a predetermined number of bytes may be allocated in each entry in the egress FC Header queues (e.g., EFPQ 36 and EPPQ 22). In one embodiment, the predetermined number of bytes is 72 bytes. When the PRC 20 needs to insert an optional header, it writes the header to one or more of these spare byte locations in the HQM 24 entry, according to one embodiment. In addition, the PRC 20 may write the length of the optional header to a field (e.g., imm_datafld_size field) of the HQM 24 entry. Once the given HQM 24 entry has been turned over to the hardware and has reached the head of the queue, the entry may be sent out to the Fibre 14. In one embodiment, the FC header is sent out first, followed by the bytes containing the optional FC header, followed by the payload. If multiple FC frames are generated from one entry in an FC Header queue, the hardware may be configured to include the optional header in each FC frame, or alternatively, in only the first frame.

C. Raw Frames

Raw FC frames may be received from the POS interface 12 and sent out on the Fibre Channel 14 using the same process used with Pass-through frames described above in Section II.A. POS frames containing encapsulated raw FC frames may be routed to the Pass-Through path. In one embodiment, the POS frame header is stripped off and is placed into an entry in the EPPQ 22, while the encapsulated FC raw frame is automatically placed into the next available segment of the EPB 40.

After the PRC 20 has been notified of the arrival of the POS frame, it may then perform the steps described above in Section II.A, except that a bit may be set in the EFPQ 36 that direct the system to take most the information needed to build the FC frame header from the raw FC frame in the EPB 40, rather than from the HQM 24 entry. In one embodiment, when this bit is set, the only fields that are taken from the HQM 24 entry are the SOF and EOF characters, and the S_ID and D_ID (i.e., Source-ID and Destination-ID, respectively). The remaining FC header fields may then be taken directly from predefined locations in the raw frame in the EPB 40.

Additional bits in the HQM 24 entry may be used by the PRC 20 to determine which mechanism will be used to generate the CRC (“Cyclic Redundancy Check”) checksum for the Fibre Channel 14 frame. In one embodiment, the possible mechanisms include: a) using the checksum located in the raw frame in the EPB 40, b) using a hardware generated checksum in the place of the one located in the EPB 40, and c) appending a hardware generated checksum to the end of the data in the EPB 40.

D. Cut-Through and Store-Forward Modes

In embodiment, ASIC 10 may provide two modes of operation. With the first mode, referred to herein as the Store-Forward mode, frames are received in their entirety from the POS interface 12 before they are sent out on the Fibre Channel 14. Alternatively, a Cut-Through Mode may be used, as described in co-pending U.S. patent application Ser. No. ______, entitled “Method and Apparatus for Implementing a Cut-Through Data Processing Model,” filed on ______, the contents of which are hereby incorporated by reference. As described therein, after a frame header and a programmable number of payload bytes have been received from the POS interface 12 in this mode, the frame may be output on the Fibre Channel 14. Thus, receiving and sending operations may overlap. In one embodiment, Cut-through mode may be enabled on a frame-by-frame basis.

E. Small FC Frames

Some Fibre Channel devices may negotiate a maximum FC payload size that is less than a nominal size, which in one embodiment is just over 2 KB. In one embodiment, this negotiated size may be 512 bytes, although other sizes may also be negotiated. In such a case, ASIC 10 may allow the Network Processor 16 to send nominal sized POS frames (e.g., 2 KB) to the ASIC 10 for such devices, but will segment the POS frame into multiple FC frames to accommodate the smaller negotiated FC payload size.

When a POS frame is received by the ASIC 10, the header and payload may be separated and routed to the EPPQ 22 and EPB 40 in the same manner described above for Pass-Through operations. In order to accommodate the smaller negotiated FC payload size, when the PRC 20 sets up an outgoing FC frame header in the EFPQ 36, it may indicate the negotiated size of the FC payload for a given device in the field in the HQM 24 entry (e.g., the ‘maximum-send-size’ field).

By way of a non-limiting example, the maximum-send-size field may be programmed with a value of 512 bytes instead of the nominal value of 2K. The remainder of the fields in the FC HQM 24 entry may then be filled in by the PRC 20 in the usual manner, after which the entry is released to the hardware. When the entry in questions in the EFPQ 36 reaches the head of the queue, the value in the ‘maximum-send-size’ field may be compared to the value in another field (e.g., the ‘expected-payload-size’ field) of the same entry. If the ‘expected-payload-size’ field is larger, the system will generate multiple Fibre Channel frames. While in one embodiment, the generated multiple FC frames each have the payload size indicated by the ‘maximum-send-size’ field, it should be appreciated that they may also have smaller payload sizes. In one embodiment, the generated FC frame use information from the original HQM 24 entry, while in another embodiment, the hardware automatically increments certain fields in the subsequent FC headers, such as the SEQ_CNT and Relative Offset fields.

Moreover, if the FC HQM 24 entry indicates that the data contained in the payload is the last data in an FC sequence, or that the FC Sequence Initiative should be transferred, the appropriate bits may be set in the header of only the last FC frame that is generated.

F. Jumbo Frames

Another aspect of the invention is for the ASIC 10 to be configurable to accept normal frames, jumbo frames, or an intermix of normal and jumbo frames from the POS interface 12. For purposes of the present discussion, a normal frame is defined as a frame whose payload can fit into a single segment of the EPB 40, while a jumbo frame is a frame whose payload spans two or more segments of the EPB 40. In one embodiment, the maximum size of a jumbo frame is configurable up to a maximum of 32K bytes.

When a jumbo frame is received on the POS interface 12, the system may automatically allocate the necessary number of EPB 40 segments to hold the frame. Also, the system may allocate an entry in the EPPQ 22 for each EPB 40 segment that is allocated. These additional HQM 24 entries do not contain copies of the POS header, according to one embodiment. Instead, they may merely contain a pointer to a EPB 40 segment and indicate that the buffer segment contains overflow data belonging to the previous entry(ies) in the POS queue of the HQM 24.

While a jumbo frame is being received on the POS interface 12, the POS HQM 24 entries that are associated with each new EPB 40 segment may be turned over to the PRC 20 incrementally as each EPB 40 segment is allocated. In one embodiment, each time the PRC 20 receives a POS HQM 24 entry, it sets up an entry in the FC queue of the HQM 24, copies the EPB 40 segment handle to it, and turns the FC HQM 24 entry over to the hardware. Using this mechanism, the hardware may send an FC frame containing the first portion of a jumbo frame payload out on the Fibre 14 while the remainder of the jumbo frame payload is still being received on the POS interface 12.

Since all of the FC frames generated from a jumbo frame will typically belong to the same context, the system is only required to set up a full FC header for the first FC frame. As will be described in more detail below in Section IV, the hardware may be programmed to automatically generate the FC headers for each subsequent FC frame based on information from the preceding frame.

If the final FC frame generated from a jumbo frame will be required to transfer the FC Sequence Initiative, or to end a sequence, the PRC 20 should know in advance what the overall length of the jumbo frame will be. In one embodiment, this may be accomplished by including a frame size field in the header of the POS jumbo frame.

G. Arbitration

In one embodiment, egress FC Frames may originate in either the EFPQ 36 or the EFIQ 34. At any point in time, there may be multiple FC frame headers in each of these queues waiting to go out on the wire.

Within each queue, FC frames will be output in the order in which they were released to the hardware, according to one embodiment. However, the same principle need not apply between queues. For example, frames that are waiting in one queue may be delayed while newer frames in the other queue go out on the Fibre 14.

In one embodiment, the arbitration algorithm has two settings: ‘ping-pong’ and ‘sequence’. When the arbiter is programmed for ping-pong mode, egress FC frames may be taken from the EFPQ 36 and the EFIQ 34 in alternating order, one at a time from each queue. When the arbiter is programmed for sequence mode, frames from the EFPQ 36 which belong to the same command context as the previous frame may be given priority. Thus, once a context begins, all frames belonging to it may be transmitted. In such a case, at the end of each context (or when the queue is empty), a frame from an FC Internal Queue (e.g., the EFIQ 34) may then be transmitted.

H. Egress Error Handling

Error handling may be accomplished by a combination of hardware error detection and software error recovery procedures. The following will describe one embodiment of the hardware detection capabilities of the ASIC 10 egress path.

Each POS frame received by the ASIC 10 will typically contain a Frame CRC checksum. When an error is detected in this checksum, a status bit may be set in the segment of the EPB 40 that received the payload, according to one embodiment. The manner in which the error may be handled is dependent (at least in part) on whether the frame header was routed to the Pass-Through Path or to the Internal Path.

If the header was routed to the Internal Path, the PRC 20 may be notified of the arrival of the frame after the payload has been fully received. In this embodiment, the PRC 20 would check the receive status before processing the payload. If this check reveals that a receive error occurred, a software recovery procedure may be called. In one embodiment, part of the software recovery procedure would include returning the EPB 40 segment to the free pool, and releasing the HQM 24 entry to the hardware.

If the header was routed to the Pass-Through path, the PRC 20 may be notified of the arrival of the POS frame after the header is received, but while the payload is still in transit. Upon notification of the arrival of the POS header, the PRC 20 may create an FC header in an entry in the EFPQ 36 and release the entry to the hardware. This will normally occur before the POS CRC error is detected.

In order to handle this situation, the hardware that assembles the outgoing FC frames may be designed to examine the receive status field of the EPB 40 segment before it initiates the FC frame. If the status field indicates that a problem was encountered while receiving the POS frame, in one embodiment the state machine may transfer this status information to the entry in the EFPQ 36, turn the entry over to the software, and halt without outputting the FC frame. The software may then decide how to recover from the error. In one embodiment, part of the recovery procedure would include returning the EPB 40 segment to the free pool and returning the FC HQM 24 entry to the hardware.

If Cut-Through Mode is enabled, the system may start sending out FC frame before the POS CRC error is detected. Such an error will typically be detected, however, before the end of the FC frame has been transmitted. When this occurs, the hardware will end the FC frame with an EOFni (End of Frame, normal Invalid), according to one embodiment. It should be appreciated that other frame termination methods may also be used including, for example EOFdti (EOF, disconnect terminate invalid. In another embodiment, the status field of the entry in the FC HQM 24 may be updated with information about the error, the entry turned over to the software, and the hardware state machine halted. It should be appreciated that the software may then decide how to recover from the error.

Moreover, an additional hardware feature may be provided to help minimize the software recovery process. In one scenario, the frame with the CRC error advanced to the head of the EFPQ 36 before the software became aware of the error. By that time, the HQM 24 could have contained headers of additional frames belonging to the same context. Furthermore, these frames could be interleaved with frames from other contexts. In order to allow the PRC 20 to easily purge frames belonging to a specific context from the HQM 24, a ‘skip’ bit may be provided in each entry in the HQM 24. When an error is detected, the PRC 20 can examine each subsequent entry in a particular queue and set the skip bit in each frame it wants to purge. In one embodiment, this may be done before the PRC 20 re-enables the hardware. Once re-enabled, the hardware may process the HQM 24 in order, beginning with the entry after the one with the error. Thus, in this embodiment, each time an entry in which the skip bit set reaches the head of queue, its contents may be ignored, the entry returned to the software and the next entry processed.

Errors may also be encountered by the Egress Fibre Control (EFC) 44 module while sending FC Frames out on the wire. Such errors may be posted in the HQM 24 entry which originated the frame. After each FC frame is completed, either successfully or un-successfully, the HQM 24 entry that originated the frame may be returned to the software. The PRC 20 may then examine the status field of the entry and if required, take appropriate recovery action.

One additional error condition may occur if Cut-Through mode is improperly set up. An error (e.g., ‘buffer under run’) can occur when a frame is being simultaneously received on the POS interface 12 and sent out on the Fibre 14. The error occurs if the speed on the sending side is greater than the speed on the receiving side and the buffer runs out of data to send. If this occurs, the logic that generates the FC Frame may terminate the frame with an EOFni. The status field of the FC HQM 24 entry that originated the frame may then be filled in with information indicating the action taken, and the entry may be turned over to the software. In one embodiment, the processing of FC frames from the Pass-through path is then halted. The software then has the option of re-transmitting the frame using the original HQM 24 entry, re-transmitting it using a new HQM 24 entry, or executing a recovery protocol.

III. Frame Ingress

A. Ingress Frame Processing

As with egress frame, each frame that is received from the Fibre Channel 14 may be routed to either the Pass-Through Path, for frames containing payloads that will be sent out on the POS interface 12, or the Internal Path for frames whose payload contains initialization, configuration or control information that will be used by an internal processor (e.g., PRC 20).

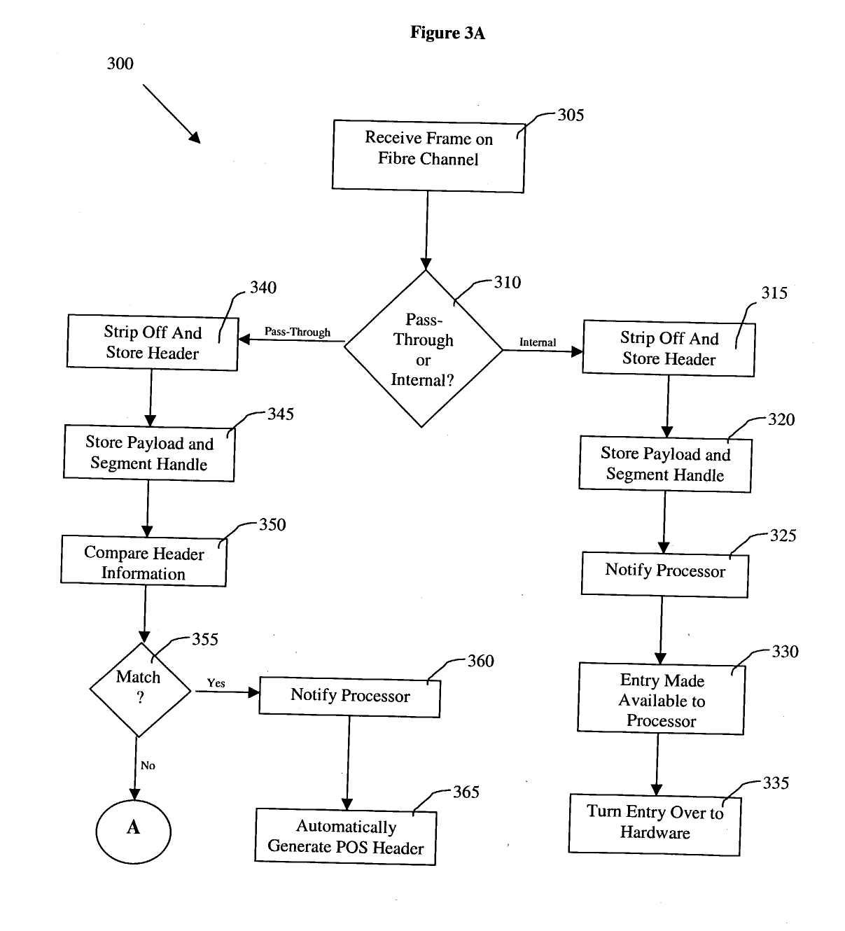

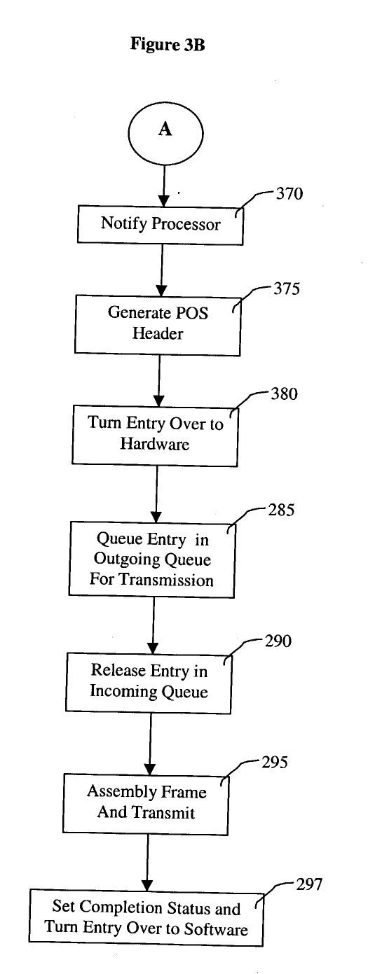

Referring now to FIG. 3, in which one embodiment of a process 300 for handling an ingress frame is depicted. At block 305, process 300 begins with ASIC 10 receiving a frame on the Fibre Channel 14, according to one embodiment. At decision block 310, a determination is made as to whether the received frame is to be routed to the Pass-Through Path or to the Internal Path. In one embodiment, the path to which the frame is routed is based on the contents of the R_CTL field in the FC frame header.

Where a determination has been made at block 315 that the received frame is to be routed to the Internal Path, the frame header may be stripped from the payload and stored in an entry in one of the queues of the HQM 24, which in one embodiment is the IFIQ 30. In another embodiment, a programmable number of bytes from the payload may also be stored along with the header in the entry of the selected queue of HQM 24.

Thereafter, at block 320, the payload may then be separated from the frame and stored in the next available segment of the IPB 38 for the given FC function (F0 or F1). A handle indicating which payload segment was used may also be stored by the hardware in the HQM 24 queue which received the FC frame header. At this point, the PRC 20 may be notified that a frame has been received, while in another embodiment the PRC 20 is notified before the entire payload has been received (block 325).

Once the PRC 20 is aware of the Internal Path frame, a programmable number of payload bytes may be made available to the PRC 20 in the entry in the IFIQ 30 (block 330). In one embodiment, the IFIQ 30 may be made available to the PRC 20 in zero-wait-state memory. Moreover, additional payload bytes may be made available to the PRC 20 via the F_LIO bus 42 (e.g., F0_LIO and F1_LIO).

After the PRC 20 has finished processing the information from the frame, it may release the entry in the IFIQ 30 to the hardware (block 335). In one embodiment, this is done by resetting a bit in the control word of the entry. In another embodiment, the PRC 20 also returns the payload buffer segment to the free pool by writing a segment handle to the payload segment release register.

If, on the other hand, a determination was made at block 215 that the frame is to be routed to the Pass-Through Path, process 300 would continue to block 340 where the received frame header is stripped from the payload and stored in an entry in an Ingress FC Queue (such as IFPQ 32) which may be dedicated to the selected function/path. A programmable number of bytes from the payload may also be stored along with the frame header in the HQM 24, according to another embodiment.

At block 345, the payload may then separated from the frame and stored in the next available segment of the IPB 38 for the given FC function (F0 or F1). A handle indicating which payload segment was used may also be stored by the hardware in the HQM 24 queue which received the FC frame header (e.g., IFPQ 32).

Thereafter, a portion of the frame header may be compared with the corresponding bytes from the previous frame's header (block 350). If the contents of the bytes are equal, a bit in the header's HQM 24 entry may be set indicating that the frames belong to the same context. It should be noted that the location of the bytes to be compared may be programmable via a bit mask.

Process 300 then may continue to decision block 355 where a determination of whether the header match bit has been set. If so, the PRC 20 may be notified that a frame has been received and that the header match bit has been set (block 360). The PRC 20 may then be used to automatically generate portions of the FC header based on values from the header of the previous FC frame (block 365). This automatic header generation will be described in more detail below in Section IV.

If, on the other hand, the determination of decision block 355 indicates that the frame is from a different context than the previous frame (e.g., header match bit not set), then process 300 continues to block 370 of FIG. 3B where the PRC 20 is notified that a frame has been received and that the header match bit was not set. At this point, the PRC 20 may be used to write the information necessary to create a suitable FC frame header (block 375). In one embodiment, the FC frame header is created in the next available entry in the IPPQ 28, although it may also be stored elsewhere. In one embodiment, the PRC 20 may also copy the payload segment handle to this IPPQ 32 entry.

After the PRC 20 has finished setting up the outgoing frame header, control of the IPPQ 32 entry may then be turned back over to the hardware by setting a bit in the entry's control word (block 380). However, it should be understood that other methods for releasing the entry may also be used. Once control of the HQM 24 entry has been turned over to the hardware, at block 385 the entry may then be queued up for transmission via the POS interface 12. In one embodiment, frames that are released to the hardware are sent out on the POS interface 12 in the order in which they were released by the PRC 20. However, it should be appreciated that frames may be sent out in any number of other orders.

After the PRC 20 has set up an outgoing entry in the IPPQ 28, at block 390 the PRC 20 may release the entry in the incoming IFPQ 28. In one embodiment, the entry is released by resetting a bit in the control word of the entry. Once released, the entry location may be reused for another ingress FC frame header.

According to the embodiment of FIG. 3B, when the entry in the IPPQ 28 reaches the head of the queue, the hardware may automatically assemble the POS frame and send it out on the POS interface 12 (block 395). When this has been completed, the hardware may put the completion status of the operation into the IPPQ 28 entry and turn the entry over to the software (e.g., PRC 20) at block 397. The IPB 38 segment may also be returned to the free pool, or it may be returned by the PRC 20 after it checks the completion status in the HQM 24 entry.

It should further be appreciated that the PRC 20 may undertake a variety of additional operations at various points during process 300 depending upon several factors, including the path and contents of the frame and whether a command context already exists. By way of example, if the PRC 20 needs to generate an ingress POS frame, in one embodiment it may do so using the IPIQ 26 and a Special Payload Buffer (not shown). In one embodiment, the Special Payload Buffer is a single segment buffer consisting of 512 bytes and resides in zero-wait-state processor memory. It should, however, be appreciated that other buffer configurations may also be used. After the PRC 20 has put the required information into the HQM 24 entry (e.g., in the IPIQ 26 entry) and Special Payload Buffer, the frame may then be released to the hardware by setting a bit in the HQM 24 entry, causing the frame to be sent out when the entry reaches the head of the particular queue.

It should also be understood that the use of the Special Payload Buffer is optional, and may only be used where the payload of the frame is too large to fit into the spare bytes in the header queue entry. By way of a non-limiting example, when a nominal configuration of 128 bytes per header queue entry is used, there are 96 bytes available in each HQM 24 entry for a POS header and POS payload. If the total number of bytes of the frame to be sent is 92 or less, the entire frame can be put into an HQM 24 entry. Otherwise, the Special Payload Buffer may be used.

After the PRC 20 has put the required information into the HQM 24 entry and Special Payload Buffer, it may then turn the frame over to the hardware by setting a bit in the HQM 24 entry. In one embodiment, the hardware will queue the entry and send the frame out on the POS interface 12 when the entry reaches the head of the queue.

B. Optional Headers

When an FC frame is received, the FC header may be separated from the payload and stored in one of the two ingress FC Header Queues (Internal or Pass-Through). In one embodiment, a programmable number of additional bytes from the FC frame are also stored in the Header Queue entry (e.g., HQM 24 entry). In another embodiment, the complete payload (everything after the FC header) may be stored in the next available segment of the IPB 38. If the bytes following the FC header contain an optional header, it may be located in the beginning of the payload buffer segment, as well as in the HQM 24 entry. In one embodiment, the PRC 20 may examine the optional header by reading it from the HQM 24 entry.

If the payload is to be forwarded to the POS interface 12, the PRC 20 may choose to exclude the optional FC header from the POS frame. In one embodiment, this is done by indicating the length of the optional header in a field (e.g., the “segment offset” field) of the ingress POS header queue entry that it generates for the frame. When the payload is transferred, the hardware may then skip the number of bytes indicated by this field when it takes the payload from the IPB 38.

C. Raw Frames

A frame that has been received on the Fibre Channel 14 may be fully encapsulated into a POS frame and sent out on the POS interface 12. In one embodiment, there are two modes available to accomplish this operation, as will now be described.

The first mode, according to this embodiment, is a dedicated raw frame mode. When the Ingress Fibre Control (IFC) 46 logic is programmed for this mode, each frame that is received from the Fibre 14 may be put into the IPB 38 in it's entirety, including FCBB characters for the SOF (Start of Frame) and EOF (End of Frame) characters of the frame. While it should be appreciated that less then the entire frame may be out into the IPB 38, for illustrative purposes the following discussion assumes that the entire frame is put into the IPB 38.

In addition to being put into the IPB 38, the FC header may also be placed into an entry in one of the ingress FC header queues (e.g., IFIQ 30 and/or IFPQ 32). From this point on, the frame may be processed in the same manner as a normal Pass-Through frame. In one embodiment, the PRC 20 creates a POS header in the next available entry in the IPPQ 28, copies the payload segment handle to the queue entry, and releases the entry to the hardware. When the entry reaches the head of the queue, the hardware may encapsulate the entire FC frame in a POS frame and send it out on the POS interface 14.

The second mode, according to this embodiment, is the interleave mode. In one embodiment, this mode allows raw frames to be interleaved with normal frames. In this mode, the hardware need not know in advance if an incoming FC frame will pass through as a raw frame, or if only the payload will be sent out on the POS interface. Moreover, in this mode the FC frame may be received in the same manner described above Section III.A.

After the PRC 20 has been notified of the arrival of the frame, it creates a POS header in the next available entry in the IPPQ 28 and copies the payload handle to the entry, according to one embodiment. The PRC 20 may then determine if the frame should be treated as a raw frame or as a normal frame.

If the frame is to be treated as a raw frame, in one embodiment the following additional steps are performed before the POS HQM 24 entry is turned over to the hardware:

First, the PRC 20 copies the FC header from the FC HQM 24 entry to the POS HQM 24 entry. In this embodiment, the FC header may be written to the spare byte locations that immediately follow the POS header. The length of the FC header may then be written to a field (e.g., the hdr_size field) in the POS HQM 24 entry. This field can be used to tell the hardware that additional bytes (the FC header) will be taken from the POS HQM 24 entry after the POS header has been transferred, but before the payload is transferred.

Next, the PRC 20 copies the FC CRC checksum from the entry in the FC HQM 24 to the entry in the POS HQM 24 entry, according to one embodiment. In another embodiment, the PRC 20 may then tell the hardware to transfer this field after the payload by setting a bit in a field of the POS HQM 24 entry. In one embodiment, the bit that is set is the imm-payld bit in the payld_src field. In yet another embodiment, the PRC 20 may also indicate the length of the CRC checksum in the imm_payld_size field of the POS HQM 24 entry.

After completing these steps, the PRC 20 may then turn the entry in the POS HQM 24 entry over to the hardware. In one embodiment, when the entry reaches the head of the queue, the hardware builds the POS frame as follows: First, the POS header is generated using data from the POS HQM 24 entry. Second, the FC Header is transferred from the POS HQM 24 entry. Third, the FC payload is transferred from the payload buffer segment. Fourth, the FC CRC is transferred from the POS HQM 24 entry. Finally, the generated POS frame CRC is transferred.

D. Cut-Through and Store-and-Forward Modes

In embodiment, ASIC 10 may provide two modes of operation. With the first mode, referred to herein as the Store-and-Forward mode, frames are received in their entirety from the Fibre Channel 14 before they are sent out on the POS interface 12. Alternatively, the Cut-Through Mode described in previously-referenced co-pending U.S. patent application Ser. No. ______ may be used. As described therein, after a frame header and a programmable number of payload bytes have been received on the Fibre Channel 14 in this mode, the frame may be output on the POS interface 12. Thus, receiving and sending operations may overlap. In one embodiment, Cut-through mode may be enabled on a frame-by-frame basis.

E. Arbitration

In one embodiment, ingress POS Frames may originate in either the IPPQ 28 or the IPIQ 26. At any point in time, there may be multiple POS frame headers in each of these queues waiting to go out on the POS interface 12.

Within each queue, POS frames will be output in the order in which they were released to the hardware, according to one embodiment. However, the same principle need not apply between queues. For example, frames that are waiting in one queue may be delayed while newer frames in the other queue go out on the POS interface 12.

In one embodiment, the arbitration algorithm has two settings: ‘ping-pong’ and ‘sequence’. When the arbiter is programmed for ping-pong mode, ingress POS frames may be taken from the IPPQ 28 and the IPIQ 26 in alternating order, one at a time from each queue. When the arbiter is programmed for sequence mode, frames from the IPPQ 28 which belong to the same command context may be given priority. Thus, once a context begins, all frames belonging to it may be transmitted in an uninterrupted fashion. In such a case, at the end of each context (or when the queue is empty), a frame from the POS Internal Queue (e.g., IPIQ 26) may then be transmitted.

F. Ingress Error Handling

As with the Egress path, Ingress error handling for may be accomplished by a combination of hardware error detection and software error recovery procedures. The following will describe one embodiment of the hardware detection capabilities of the ASIC 10 ingress path.

In one embodiment, each FC frame received by ASIC 10 will typically contain a frame CRC checksum and an EOFni transmission word. When a checksum error or an EOFni is detected, or any other Fibre-Channel-specific error is detected during the reception of a frame, a status bit may be set in the segment of the IPB 38 that received the payload. Moreover, the manner in which the error is handled may be dependent on whether the frame header is routed to the Pass-Through Path or the Internal Path.

If the frame is routed to the Internal Path, the PRC 20 may be notified of the arrival of the frame after the payload has been fully received. The PRC 20 may then check the receive status before processing the payload. In one embodiment, if the check reveals that an error condition occurred while receiving the FC frame, a software recovery procedure is called. It should be appreciated that the software recovery procedure called may include returning the payload buffer segment to the free pool, and releasing the HQM 24 entry to the hardware.

If the frame is routed to the Pass-Through Path, the PRC 20 may be notified of the arrival of the FC frame after the header is received, but while the payload is still in transit. In one embodiment, upon notification the PRC 20 creates a POS header in the IPPQ 28 and releases the entry to the hardware. While this will normally occur before the POS CRC error is detected, it may also occur afterwards.

In order to handle this situation, the hardware that assembles the outgoing POS frames may be designed to also examine the status field of the indicated payload buffer segment before it initiates each POS frame. In such an embodiment, if the status field indicates that a problem was encountered while receiving the FC frame, the state machine may transfer this status information to the POS HQM 24 entry, turn the entry over to the software, and halt without generating the POS frame. The software may then decide how to recover from the error. In one embodiment, the recovery procedure includes returning the payload buffer segment to the free pool and returning the POS HQM 24 entry to the hardware.

If, on the other hand, Cut-Through Mode is enabled, the hardware may start sending the POS frame out before the FC receive error has been detected. The error will typically be detected, however, before the end of the POS frame has been transmitted. When this situation occurs, the hardware may be given the option (programmable) of either corrupting the outgoing POS frame CRC, or indicating a ‘Receive Frame’ error on the POS interface 12. In either case, the status field of the entry in the POS HQM 24 may be updated with information about the error. In one embodiment, the entry is also turned over to the software and the hardware state machine halted. In such a case, the software may then decide how to recover from the error.

In the example given above, the frame with the CRC error advanced to the head of the IPPQ 28 before the software became aware of the error. By that time, the queue could have contained headers for additional frames belonging to the same context. Furthermore, these frames could be interleaved with frames from other contexts. In order to allow the PRC 20 to easily purge frames belonging to a specific context from the queue, a ‘skip’ bit may be provided in each queue entry. In this embodiment, when an error is detected the processor can examine each entry in the queue and set this bit in each frame it wants to purge. Thereafter, the queue may be processed in order, beginning with the entry after the one with the error. Thus, in one embodiment, each time an entry with the skip bit set reaches the head of the queue, its contents may then be ignored, the entry returned to the software, and the next entry in the queue is processed.

In this manner, circular queue elements in dual port memory (e.g., EFPQ 36, EFIQ 34, EPPQ 22, EPIQ 18, IFIQ 30, IFPQ 32, IPIQ 26, and IPPQ 28) may be used for passing packet/frame header information and control information between the hardware and a microprocessor (e.g., PRC 20).

IV. Automatic Header Generation

As mentioned above, another aspect of the invention is to use a hybrid approach to generating headers for both FC frames, as well as POS frames. In one embodiment, the PRC 20 may be used to set up initial values for particular frame header fields, and thereafter the hardware may reuse these values until the PRC 20 determines that new values are needed.

Moreover, certain other fields of a frame header may contain data that differs from one frame to the next, but that is predictable and can be calculated by the hardware. For these fields, as will be described in more detail below, the PRC 20 may set up initial values for the fields, and thereafter the hardware may be used to calculate new values for use in subsequent frames. The hardware may update the fields in the HQM 24 entry associated with each frame it generates with new values, according to one embodiment. The PRC 20 may then be provided with the exact values that were contained in the fields generated by the hardware. This allows software executing on the PRC 20 to update, or keep current, the context data structures after each frame has been sent.

A. Header Generation Overview

In one embodiment, software executing on the PRC 20 has the option of (1) building each frame header in its entirety, (2) having hardware assist in the header generation by copying selected fields from the previous frames header, and/or (3) having the hardware calculate values for certain pre-defined fields within each header. These three header generation mechanisms or a combination thereof may be implemented on a frame-by-frame basis by fields in the control section of the HQM 24 entry associated with each frame.

While the first header generation mechanism may be the least efficient option since the PRC 20 is required to create the complete header image for each frame, it may be desirable to implement in certain circumstances. With the second header generation mechanism processing efficiencies can be gained by using a header buffer to contain an image of the header of the most recently sent frame (whether POS or FC). Bytes of this previous header may then be copied into the new header by the hardware, according to one embodiment. In one embodiment, this header generation option is chosen on a frame-by-frame basis by a field in the HQM 24 entry that is associated with the given frame. This field (e.g., the FRM_GEN_MSK field) may also be used to determine which bytes from the header buffer will be copied into the header of the new frame. Moreover, after the new frame has been sent out (either on the POS interface 12 or the Fibre Channel 14), it's header may replace the image saved in the header buffer, according to one embodiment.

In another embodiment, a separate set of hardware mechanisms may be used to generate data for special control fields in the frame headers. The control fields may be used to determine (a) the source of the data put into the header, (b) whether or not the values from the current HQM 24 entry will be used to initialize the hardware mechanisms, and (c) whether or not the current HQM 24 entry will be updated with the generated values after the header has been created. In one embodiment, the control fields may then used by the PRC 20 to determine what the initial value for the next frame should be.

Two examples of such control fields are the Frame-ID field and the Relative-Offset field. In one embodiment, the Frame-ID field contains incremental data, where the Frame-ID field in each header contains a value from the previous header incremented by one. In one embodiment, a hardware mechanism may be used to automatically increment this field from one frame to the next.

The Relative-Offset field contains arithmetic sum information, according to one embodiment. The value for this field may be calculated by adding the number of bytes transferred by the previous frame to the Relative-Offset value of the first byte of that frame. This calculation provides the Relative-Offset value of the first byte of the subsequent frame in the sequence. In one embodiment, a hardware mechanism may be used to perform this calculation for each frame, and save the result for use in the subsequent frames' header.

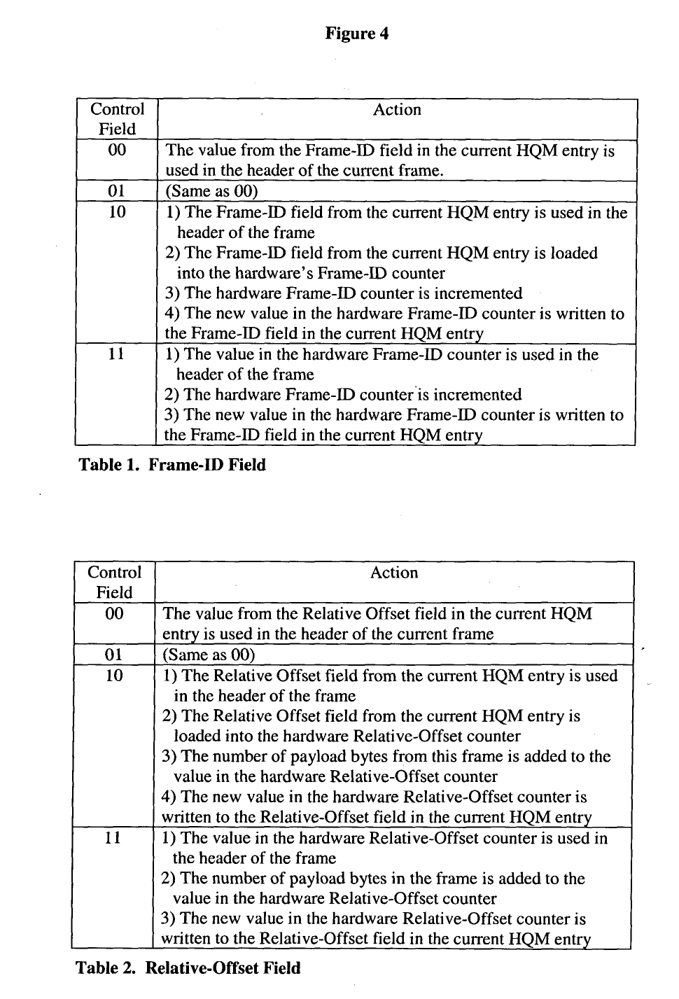

By way of providing a non-limiting example, FIG. 4 is provided to show one embodiment of the values for two potential control fields—the Frame-ID field and the Relative-Offset field.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus to bridge network protocols comprising:
a memory coupled to a first network interface, said memory to include a plurality of memory queues;
a circuit coupled to the first network interface and said memory, said circuit to,
store a header of a data frame in a first entry of said plurality of memory queues, said data frame to have a source protocol and be received on said first interface, and
provide notification of said data frame upon storing of a programmable number of bytes of the data frame; and
a processor coupled to the circuit and the memory, the processor to assume control of said first entry after receiving said notification, said processor to generate an outgoing header based on said header, said outgoing header to have a destination protocol.

2. The apparatus of claim 1, wherein said circuit further sets a control bit for said first entry after storing said header, said processor to assume control of the first entry based on the control bit.

3. The apparatus of claim 2, wherein said processor, after generating said outgoing header, passes control of the first entry back to the circuit by resetting said control bit.

4. The apparatus of claim 2, wherein said processor further to,
store said outgoing header in a second entry of said plurality of memory queues,
pass control of the first entry back to the circuit by resetting the control bit for said first entry, and
pass control of the second entry to the circuit by setting a control bit for the second entry.

5. The apparatus of claim 4, wherein said second entry is located in a different queue within the plurality of memory queues.

6. The apparatus of claim 4, wherein said circuit, after assuming control of the first entry based on said control bit for the first entry, is further to
store a second header of a second data frame in the first entry of the queue, said second header to have the source protocol and to be received on the first interface,
set the control bit for said first entry to allow said processor to assume control of said first entry, and
provide a second notification of said second data frame to the processor, said processor to assume control of the first entry based on the control bit for the first entry.

7. The apparatus of claim 4, wherein said circuit, after assuming control of the second entry based on said control bit for the second entry, is further to assemble an outgoing frame according to the destination protocol using the outgoing header in said second entry, and to transmit said outgoing frame on a second interface of said apparatus.

8. The apparatus of claim 7, wherein said data frame further includes a payload that is stored in a buffer of said apparatus by said circuit, and wherein said circuit assembles said outgoing frame using the outgoing header and the payload.

9. The apparatus of claim 1, wherein said data frame includes a payload and one or more path routing bits to be used by said circuit to determine if said data frame is an internal frame and, if so, to provide at least a portion of said payload to the processor.

10. The apparatus of claim 1, wherein said data frame further includes a payload, said circuit further to separate said payload from the data frame and store said payload in a buffer.

11. The apparatus of claim 10, wherein said buffer is segmented and the payload is stored in a segment of the buffer, said circuit to store a segment handle with said header in the first entry, where said segment handle is representative of said segment.

12. The apparatus of claim 1, wherein said source protocol is packet-over-SONET and the destination protocol is Fibre Channel.

13. The apparatus of claim 1, wherein said source protocol is Fibre Channel and the destination protocol is packet-over-SONET.

14. The apparatus of claim 1, wherein one of the source protocol and destination protocol is one of System Parallel Interface, Utopia and FlexBUS™.

15. The apparatus of claim 1, wherein each of said plurality of memory queues is shared dual-port RAM that is accessible by both the circuit and the processor.

16. The apparatus of claim 1, wherein said processor is further to set a skip bit in an outgoing entry associated with the outgoing header when an error associated with the data frame has been detected, and wherein said circuit will skip the outgoing entry upon detecting said skip bit.

17. The apparatus of claim 16, wherein said circuit will not generate said outgoing header for said outgoing entry.

18. The apparatus of claim 16, wherein said circuit returns control of said outgoing entry to said processor after said outgoing entry has been skipped.

19. The apparatus of claim 16, wherein said circuit continues processing additional entries after skipping said outgoing entry.

20. The apparatus of claim 1, wherein said circuit is further to compare at least a potion of said header with a previous header, and if there is a match, said circuit is further to set a header match bit for said header.

21. The apparatus of claim 20, wherein said processor, upon detecting that said header match bit has been set, generates said outgoing header using at least a portion of said previous header.

22. The apparatus of claim 4, wherein a predetermined number of bytes of said second entry is allocated for one of a processor-generated payload and an optional processor-generated header.

23. The apparatus of claim 22, wherein at least a portion of said processor-generated payload may be stored in special payload buffer when said processor-generated payload exceeds said predetermined number of bytes of said first entry.

24. The apparatus of claim 1, wherein when a payload of said data frame exceeds a predetermined maximum payload size, said data frame is segmented into a plurality of smaller frames that have payloads not greater than said predetermined maximum payload size.

25. The apparatus of claim 1, wherein if said data frame is a jumbo frame, said header will be stored in the first entry and a payload of said data frame will be stored in a plurality of buffer segments, where each of said plurality of buffer segments will be allocated an additional entry in said plurality of memory queues.

26. The apparatus of claim 21, wherein each of said additional entries includes a pointer to a corresponding segment from said plurality of buffer segments.

27. An method to bridge network protocols comprising:
receiving a data frame having a source protocol over a first interface;
storing a header of the data frame in a first entry of a plurality of memory queues in response to an output from a circuit;
notifying, by said circuit, a processor of said data frame upon storing a programmable number of bytes of the data frame;
assuming control, by the processor, of the first entry after said notifying; and,
generating an outgoing header using said processor based on information in said header, said outgoing header to have a destination protocol.

28. The method of claim 27, further comprising setting a control bit using said circuit for said first entry after said storing, and wherein said assuming control by the processor is based on said control bit.

29. The method of claim 28, further comprising passing control of the first entry from said processor to said circuit by having said processor reset said control bit after said generating of the outgoing header.

30. The method of claim 29, further comprising:
storing said outgoing header in a second entry of said plurality of memory queues using the processor;
passing control of the first entry back to the circuit by resetting the control bit for said first entry using the processor; and,
passing control of the second entry to the circuit by setting a control bit for the second entry using the processor.

31. The method of claim 30, wherein after said passing control of the first entry back to the circuit, the method further comprises:
storing a second header of a second data frame in the first entry of the queue using the circuit, said second header to have the source protocol and to be received on the first interface;
setting the control bit, using the circuit, for said first entry to allow said processor to assume control of said first entry; and,
providing a second notification by said circuit of said second data frame to the processor, said processor to assume control of the first entry based on the control bit for the first entry.

32. The method of claim 30, wherein after said assuming control of the second entry based on said control bit for the second entry, the method further comprises:
assembling an outgoing frame using the circuit according to the destination protocol using the outgoing header in said second entry; and
transmitting, by the circuit, said outgoing frame on a second interface of said apparatus.

33. The method of claim 27, wherein said data frame further includes a payload that is stored in a buffer of said apparatus by said circuit, the method further comprising assembling, by the circuit, said outgoing frame using the outgoing header and the payload.

34. The method of claim 27, wherein said data frame includes a payload and one or more path routing bits, the method further comprising determining, by the circuit, if said data frame is an internal frame and, if so, providing at least a portion of said payload to the processor.

35. The method of claim 27, wherein said data frame further includes a payload, and the method further comprises:
separating said payload from the data frame using the circuit; and
storing said payload in a buffer.

36. The method of claim 35, wherein said storing comprises storing said payload in a segment of the buffer where said buffer is segmented, the method further comprising storing a segment handle, using the circuit, with said header in the first entry, where said segment handle is representative of said segment.

37. The method of claim 27, wherein said source protocol is packet-over-SONET and the destination protocol is Fibre Channel.

38. The method of claim 27, wherein said source protocol is Fibre Channel and the destination protocol is packet-over-SONET.

39. The method of claim 27, wherein one of the source protocol and destination protocol is one of System Parallel Interface, Utopia and FlexBUS™.

40. The method of claim 27, wherein each of said plurality of memory queues is shared dual-port RAM that is accessible by both the circuit and the processor.

41. The method of claim 27, further comprising:
setting a skip bit, by said processor, in an outgoing entry associated with the outgoing header when an error associated with the data frame has been detected; and,
skipping the outgoing entry, by said circuit, upon detecting said skip bit.

42. The method of claim 41, wherein said skipping the outgoing entry comprises skipping said generating the outgoing header for said outgoing entry.

43. The method of claim 41, further comprises returning control of said outgoing entry to said processor after said skipping skipped the outgoing entry.

44. The method of claim 41, further comprising processing additional entries after said skipping said outgoing entry.

45. The method of claim 27, further comprising comparing at least a potion of said header with a previous header using the circuit, and if there is a match, the method further comprises setting a header match bit for said header using said circuit.

46. The method of claim 45, where said comparing indicates a match, the method further comprises generating, by said processor, said outgoing header using at least a portion of said previous header.

47. The method of claim 30, further comprising allocating a predetermined number of bytes of said second entry for one of a processor-generated payload and an optional processor-generated header.

48. The method of claim 47, further comprising storing at least a portion of said processor-generated payload in special payload buffer when said processor-generated payload exceeds said predetermined number of bytes of said first entry.

49. The method of claim 27, wherein when a payload of said data frame exceeds a predetermined maximum payload size, the method further comprises segmenting said data frame into a plurality of smaller frames that have payloads not greater than said predetermined maximum payload size.

50. The method of claim 27, wherein if said data frame is a jumbo frame, the method further comprises:
storing a payload of said data frame in a plurality of buffer segments; and
allocating each of said plurality of buffer segments an additional entry in said plurality of memory queues.

51. The method of claim 50, wherein each of said additional entries includes a pointer to a corresponding segment from said plurality of buffer segments.
